(19) United States
(12) Patent Application Publication
(10) Pub. No.: US 2019/0259106 A1
(43) Pub. Date: Aug. 22, 2019

(54) TheGig entertainment availability application and process

(71) Applicant: Glenn Cipolla, Salisbury, MA (US)

(72) Inventor: Glenn Cipolla, Salisbury, MA (US)

(21) Appl. No.: 15/900,812

(22) Filed: Feb. 21, 2018

(51) Int. Cl. G06Q 50/00; H04L 12/18; G06Q 30/02; G06F 17/30

(52) U.S. Cl. CPC G06Q 50/01; G06F 17/30864; G06Q 30/0282; H04L 12/1813

(57) ABSTRACT

A system and method for accumulating data regarding local music events (gig) transpiring at a particular locality through manual data entry or scraping of data by technology or scraping of social media technology by API or manual data entry by users and then displaying the output as per user selection through its website or app. The method is additionally auxiliary in all providing the chat option for the users, tipping the band, booking the bands for events, heedfully aurally perceiving and visually examining of live broadcast, articles and content on events and online shopping of promotional products.

### BACKGROUND

### Field of the Invention

The present invention relates to a systems and methods of an entertainment application which provides local entertainment options to its users. This app responds to the user on behalf of the selection of user. More particularly, in response to receiving a query regarding the music options, the system determines and displays the details with further option of Indie music meaning live local music options available.

### Description of the Related Art

Music is found in every known culture, past and present, varying widely between times and places. Since all people of the world, including the most isolated tribal groups, have a form of music, it may be concluded that music is likely to have been present in the ancestral population prior to the dispersal of humans around the world. Consequently, music may have been in existence for at least 55,000 years and the first music may have been invented in Africa and then evolved to become a fundamental constituent of human life.

The 20th Century saw a revolution in music listening as the radio gained popularity worldwide and new media and technologies were developed to record, capture, reproduce and distribute music. Music performances became increasingly visual with the broadcast and recording of music videos and concerts. Music of all kinds also became increasingly portable. Headphones allowed people sitting next to each other to listen to entirely different performances or share the same performance.

20th Century music brought a new freedom and wide experimentation with new musical styles and forms that challenged the accepted rules of music of earlier periods. The invention of musical amplification and electronic instruments, especially the synthesizer, in the mid-20th century revolutionized popular music and accelerated the development of new forms of music. Recorded music is a dynamic art form, frozen in a static format. Unlike static art forms like painting or sculpture, the experience of listening to live music is dynamic.

On-demand music data distribution services are provided recently on the Internet from a World Wide Web server to a user terminal or the like. One example of the user terminal is a personal computer. In this case, the personal computer accesses a WWW server via a communication unit such as a modem to download desired music data, and automatically plays the music data by using an external musical tone generator or by running a musical tone generator program.

People like to listen to music wherever they are or whenever they can. Music has always a demand and people like to pass their leisure time by attending concerts or event (gig)s where they can relax and enjoy with their family or friends. Whenever a weekend comes or some holiday season comes people plan for activities. They want to take out the time from their routine activities and do something cheerful and delightful. This app has been made with this purpose that will allow the users to have an interface where they can view the current happening planned in their own locality.

Hence it is desirable to provide a communication system that acquire data of Indie music meaning local entertainment including music shows, event (gig)s, arts & crafts exhibition, karaoke, comedy shows, kids show and all other types of events happening in the vicinity and present them to user.

It is further desirable to provide a communication system that allows the user to rate, review, tip and chat using the website or app.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to a method to conveniently allow the user to look for the Indie music meaning local music event (gig)s planned in their locality

The invention will also provide the user reviews and articles on the places to be or the best venues or possibilities available in their own locality

It is further object of the invention to allow the user to connect to other users through Chat facility and discuss the event (gig)s.

It is furthermore object of the invention to allow the user to rate, review or tip the band

It is also the objective of the invention to allow the user to purchase the tickets of local event (gig), promotional products and other souvenirs through website and app

It is furthermore the objective of the invention to gather the data by manual input, scraping of data by technology, scraping of social media technology by API and manual data entry by the venues and bands.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, FIGURE, and Claims.

### BRIEF DESCRIPTION OF THE DRAWINGS

The accompanying FIGURE, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is given in the diagram section.

FIG. 1 explains the complete flow process of the new app and services provided to clientele bringing a new theme in web based music industry.

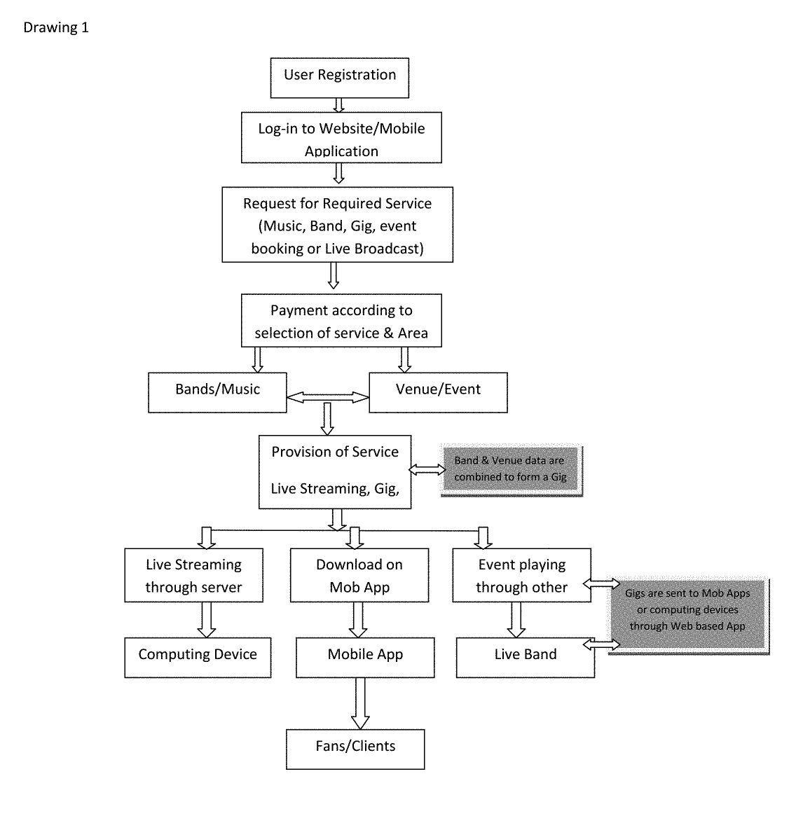

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

According to one aspect of the present invention, there is provided a music data providing apparatus comprising: a memory that stores a plurality of music data grouped as per locality and a plurality of advertisement data; a receiver that receives a request for a desired music data from a user via a network; a built in program that bring the data stored in said memory to the music data corresponding to the received request; and a transmitter that transmits the music data appended with or without the advertisement data to the user via the network.

According to another aspect of the present invention, there is provided a music data receiving apparatus comprising: a transmitter that transmits a request for a desired music data to a server connected to a network; a receiver that receives a query in form of group of data and the requested music information data transmitted from the server via the network; a display that displays the information about Indie music meaning local music event (gig)s corresponding to the received data.

The data source for the system can be through manual data entry, screen scraping, social media scraping and the bands and venues entering the information themselves through the website user login area.

A user can enter various information or perform other controls by using an operation unit (input unit) connected to the detector circuit. The operation unit may be any device capable of outputting signals corresponding to inputs, such as a mouse, a keyboard, a musical keyboard, a joystick, and a switch. A plurality of operation units may be connected.

According to one embodiment of the invention the system stores in its memory of all of the music or event (gig)s happening. This data is stored categorically as per locality of each event (gig). When requests for event (gig)s happening at a particular area, he/she will get that area data only. The user can get the information on all types of event (gig)s happening including but not limited to live music event (gig)s, open mic nights, music festivals, party event (gig)s or other gatherings. This data is gathered only on local basis, the information on famous venues with celebrities isn't included in the stored data.

In another embodiment of the invention user can also view and review the articles that are available on the website or app which can be a review of specific place, band or event (gig). Users can comment and provide their feedback.

In further embodiment of the invention user can review or rate the bar, event (gig), band, song, musician, food/drink, restaurant, or any other activity they attended. The user can also tip the band through the app tip function. The user can further check the availability of multiple bands and can book for their event (gig)s.

In other embodiment of the invention user can purchase their tickets online and can also avail coupons and discounts. Users can also purchase bars, promotional products such as t-shorts, mugs, wrist bands, badges or other promotional stuff through the app or website store area.

In further embodiment of the invention the system will also maintain the information of each user and will create the further events (gig) recommendations according to member's past browsing trends, events attendance history and general views and ratings of the best bands, bars and events happening in the locality.

In further embodiment of the invention the user can also listen to a local event (gig) in case they are interested and have missed it. The user can also have the option of live broadcast both audio and video.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A music event (gig) data providing system and method comprising:
a memory that stores a plurality of music events (gig) data,
a receiver that receives a request for a desired music event (gig) data from a user via a network;
a transmitter that transmits the music event (gig) data to the user via the network, and
a user display panel which can be a computer screen, smart device or a cell phone that produces the desired output on the screen.

II: The music event (gig) data providing apparatus according to claim II, wherein the data can comprise of information about events happening at a certain locality or reviews or articles.

III: The music event (gig) data providing apparatus according to claim II, wherein the user can send query inform of events happening at a particular place, comments or reviews or for purchase of items from online store.

IV. The music event (gig) data providing apparatus according to claim I, wherein said transmitter is capable of wireless communication

V. A music event (gig) data providing system which according to claim I, provides chat option through its website or app allowing user to communicate and discuss events

VI: A music event (gig) data providing system which according to claim IL provides a tip option for the favorite band from a registered user

VII: A music event (gig) data providing system which according to claim IL provides the members information about further events scheduled and happening in their vicinity.
